(19) United States
(12) Patent Application Publication
(10) Pub. No.: US 2004/0263342 A1
(43) Pub. Date: Dec. 30, 2004

(54) System for monitoring motors

(76) Inventors: Milton Gregory Matlock, Collegeville, PA (US); Kyle Leonard Roozen, San Jose, CA (US); James Steven Mokri, Los Gatos, CA (US)

Correspondence Address: HARNESS, DICKEY & PIERCE, P.L.C., P.O. BOX 8910, RESTON, VA, 20195, US

(21) Appl. No.: 10/608,087

(22) Filed: Jun. 30, 2003

(51) Int. Cl. G08B 21/00

(52) U.S. Cl. 340/648; 340/438

(57) ABSTRACT

A monitoring system for motors, particularly electric motors, monitors the operating conditions of the motor using a plurality of sensors. Data relating to the operating conditions is compared to predetermined criteria to determine if a threshold has been exceeded, with a warning indication provided. The data is stored within a data storage device that may be removed from the monitoring system for access thereto.

### TECHNICAL FIELD AND INDUSTRIAL APPLICABILITY OF THE INVENTION

The present invention relates generally to motors, and more particularly to a system for monitoring operating conditions of motors.

### BACKGROUND OF THE INVENTION

Monitoring of motors, and in particular electric motors, to determine when certain operating conditions exceed acceptable tolerance levels is critical in many applications. The failure of a single motor in a system may result in the total failure of the system and the temporary shutdown of a facility or plant (e.g., nuclear power plant). Further, the motor typically will have to be repaired or replaced, adding to the shutdown time and associated cost. Monitoring of motors also allows for determining when appropriate maintenance is needed, which may result in extending the useful life of the motors.

In large facilities, for example, a nuclear power plant, monitoring of the many motors therein may be a complex and time consuming process. For example, plant personnel may be required to manually record, analyze, interpret, determine trends, and maintain operating condition data on plant motors to ensure proper operation. It is known to provide wireless monitoring systems or hardwired monitoring devices to monitor motors, for example, within a nuclear power plant and to assist personnel in this process. However, wireless monitoring systems and networks may cause radio interference to nuclear plant safety systems and are therefore difficult to qualify and apply. The use of wireless devices, for example, Personal Digital Assistants (PDA's) for monitoring and to obtain operating condition data from motors lacks robustness, as well as the memory capacity needed to store sufficient data from multiple motors. Hardwiring communication cable throughout the plant may require a plant modification often making the hardwiring of a monitoring device cost prohibitive. Thus, these monitoring systems may be difficult and costly to install, often fail to provide acceptable performance and may interfere with other operations within a plant.

### SUMMARY OF THE INVENTION

A monitoring system of the present invention, and more particularly a monitoring system for monitoring motors, for example electric motors in a nuclear power plant, is provided without the need for plant modification. The monitoring system includes a plurality of sensors for monitoring motor conditions and operating parameters thereof, data analysis and data storage components for analyzing and storing the data, and condition assessment and reporting functionality. The monitoring system may monitor mechanical and electrical parameters of a motor while in standby and operating modes, compare the operating data to acceptable operating levels, and store data on a local data storage device.

In one embodiment of the present invention, a monitoring system for a motor includes a plurality of sensors for monitoring operating conditions of the motor, and a removable data storage device for storing data relating to the monitored operating conditions. The monitoring system further may include a database having stored therein tolerance values for operating conditions and a data analysis component for comparing the data relating to the monitored operating conditions to the tolerance values in the database, with the data analysis component configured to provide a warning indication when a tolerance value is exceeded. The operating conditions may include one of bearing temperature, winding temperature, ambient temperature, oil condition, vibration, insulation resistance and current; with the plurality of sensors configured to separately monitor each of the operating conditions.

### BRIEF DESCRIPTION OF THE DRAWINGS

The present invention will become more fully understood from the detailed description and the accompanying drawings, wherein:

FIG. 1 is a simplified diagram of one embodiment of a monitoring system of the present invention in connection with a motor;

FIG. 2 is a block diagram of one embodiment of a monitoring system of the present invention showing the component parts thereof; and

FIG. 3 is a detailed block diagram of one embodiment of a monitoring system of the present invention.

### DETAILED DESCRIPTION AND PREFERRED EMBODIMENTS OF THE INVENTION

The following description and preferred embodiments is merely exemplary in nature and is in no way intended to limit the invention, its application, or uses. Although the present invention is described in connection with a monitoring system having particular component parts, including specific sensors for monitoring specific conditions of a motor, it is not so limited, and different or additional component parts, including sensors, may be provided to monitor different conditions relating to different motors.

A detailed structural description of a monitoring system of the present invention will first be provided. Thereafter, a detailed operational description of the monitoring system will be provided.

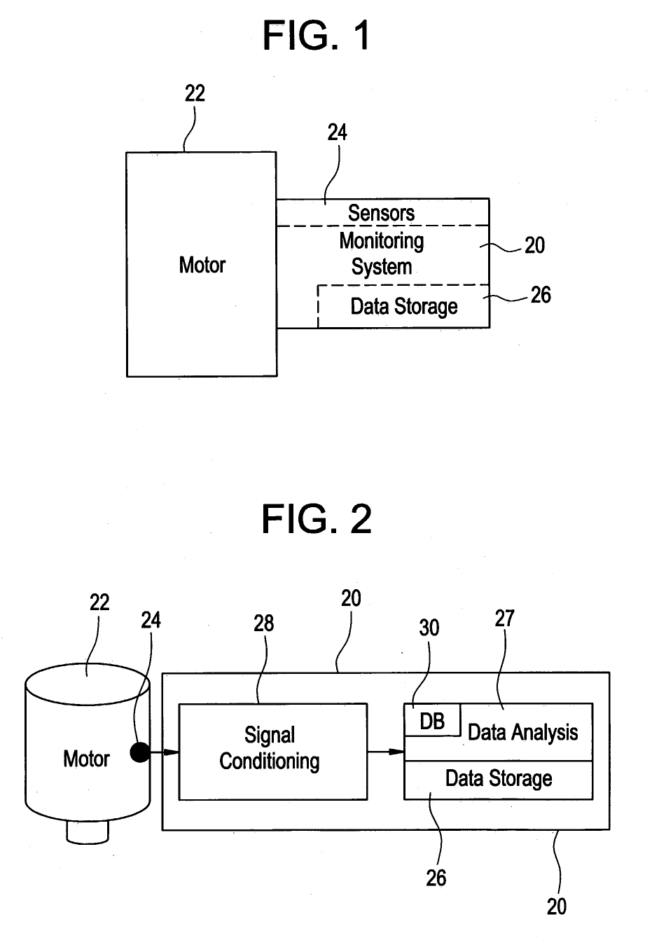

Various embodiments of the present invention provide a monitoring system for use in monitoring and storing operating data (e.g., operating condition data) relating to the operation of motors, especially electric motors. In one embodiment, as shown generally in FIG. 1, a monitoring system 20 is provided for monitoring the operating conditions of a motor 22 (e.g., electric motor) and includes one or more sensors 24 for monitoring the operating conditions. A storage device 26 is also provided for storing data relating to the operating conditions of the motor 22. In one specific embodiment, the monitoring system 20 is mounted to the motor 22 and uses sensors 24 to monitor specific operating parameters of the motor 22 (e.g., winding insulation resistance, motor current, winding temperature, bearing temperatures, ambient temperature, oil condition, vibration and external visual condition). The monitoring system 20 includes data access ports to transfer on-line and off-line (e.g., power on and power off) operating data to, for example, a portable data collection device, which in this embodiment is a removable data storage device 26. The data storage device 26 is thereby configured for periodic removal and/or replacement (e.g., connecting another data storage device 26 thereto) allowing for the operating data to be downloaded to, for example, a computer, for distribution and analysis.

In one particular embodiment, as shown in FIG. 2, the monitoring system 20 includes one or more sensors 24 connected to a motor 22 for monitoring the operating conditions of the motor 22 and obtaining operating data that is stored within the data storage device 26. Further, a signal conditioning component 28 is connected to and receives signals from the one or more sensors 24, and conditions the signals for use by a data analysis component 27 (e.g., converts signals representing operating data to a particular standard). The data analysis component 27 receives and analyzes (e.g., compares to threshold values) the conditioned signal from-the signal conditioning component 28.

Specifically, a plurality of sensors 24 are provided, each configured for monitoring an operating condition or parameter of the motor 22. For example, specific sensors 24 may be provided as follows and as described in more detail herein:

(1) Thermocouples to monitor ambient, upper bearing, lower bearing and winding temperature.

(2) Vibration sensors to monitor x-axis and y-axis motor vibration.

(3) Oil condition sensors to monitor upper and lower oil reservoir conditions.

(4) An insulation resistance (IR) sensor to monitor stator winding insulation.

(5) A current transformer (CT) to monitor average motor power and motor current signature analysis (MCSA) conditions.

It should be noted that the monitoring system 20 is not limited to particular monitoring devices, such as the sensors 24 described herein. For example, a small tube-like or CCD camera may be provided for visual inspection in critical areas within the motor 22. Further, a user activated component may be provided for use in indicating, for example, a potential problem with the motor 22 identified from an external inspection (e.g., indicating that an external condition of the motor may be outside predefined criteria at the time of the inspection).

It also should be noted that when reference is made herein to monitoring a motor 22, this refers to, but is not limited to measuring operating conditions and parameters of the motor 22 during power on, power off, normal operating and standby conditions. Further, the measured operating data may be compared to acceptable values to determine if and when tolerances are exceeded. The measured data also may be stored for future access and analysis.

Referring again to FIG. 2, the signal conditioning component 28 receives signals from the sensors 24 representative of the operating conditions and/or operating parameters of the motor 22, and converts the signals for use by the data analysis component 27 and storage within the data storage device 26. For example, the signal conditioning component 28 may convert signals from the sensors 24 to standard 4-20 milli-Amp (mA) signals for processing by the data analysis component 27 and storage within the data storage component 26. In one embodiment, the data analysis component 27 and data storage device 26 are configured to receive a defined range of either voltage or current inputs. In this embodiment, the signal conditioning component 28 will convert signals outside the voltage or current range that are received from the sensors 24 to signals within the defined voltage or current range.

The data analysis component 27 of one embodiment of the present invention includes a database 30 having stored therein operating condition values for the operating conditions and parameters being monitored by the sensors 24. In particular, the database 30 includes tolerance values for the operating conditions or parameters of the motor 22 being monitored for use in comparison with the actual monitored values. Further, the data analysis component is configured having multiple input channels for receiving data separately from each of the sensors 24 at the same time.

The data storage device 26 is configured in one embodiment as a removable storage unit such as, for example, a memory flash card, a PCMCIA card or a data logger. Further, the data logger may be, for example, a Spectrum logger sold by Veriteq Instruments, Inc., a ModuLogger sold by Logic Beach, Inc., a 12-Channel Portable/Mixed Signal data logger sold by National Instruments Corporation, a Fluke 2680 Series data logger sold by Fluke Corporation, a MadgeTech data logger sold by MadgeTech., Inc. or an Owl Model 5oo data logger sold by ACR systems, Inc. In this embodiment, the data analysis component 27 includes a multi-channel Programmable Logic Controller (PLC) having the removable storage unit connected thereto, for example, a PCMCIA card connected thereto. Operating data received by the PLC from the sensors 24 is converted by the signal conditioning component 28 and stored within the PCMCIA card. Thus, a user (e.g., a plant technician) may replace the PCMCIA card from the PLC with another PCMCIA card when it is time to retrieve the operating data (e.g., periodically or when a warning indication is provided).

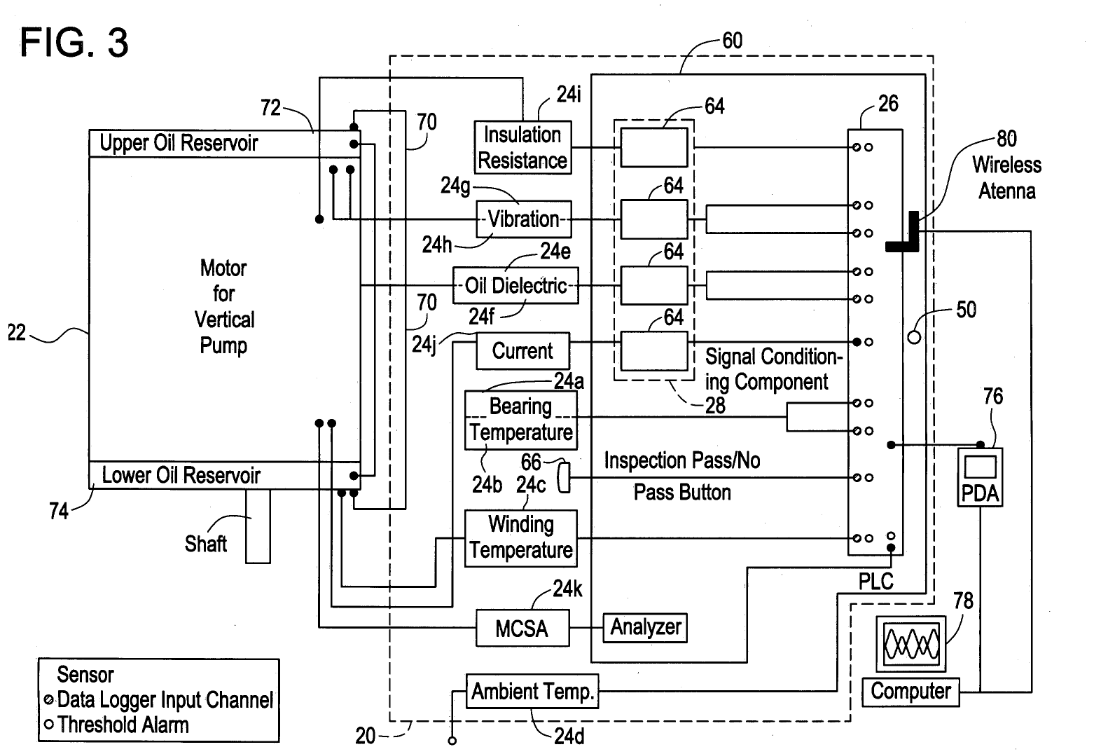

The data analysis component 27 is configured to perform analysis of the received operating data from the sensors 24, such as for example, to compare the operating data to rule-based criteria (e.g., tolerance values stored within the database 30) and provide an indication when a particular condition has been exceeded, such as, for example, when a tolerance value is exceeded. An indication light 50 (shown in FIG. 3) may be provided to alert a user that, for example, operating data should be retrieved for analysis because a threshold has been exceeded. Further, the data storage device 26 is configured such that operating data may be stored at predetermined time intervals (e.g., every hour) and for a predetermined time period (e.g., one month) before downloading the operating data, for example, to a computer for viewing and analysis. For example, the retrieved operating data may be downloaded from the data storage device 26 and distributed (e.g., via email) to a particular utility (e.g., nuclear power plant) having the motor 22 being monitored therein. The retrieved operating data also may be distributed to a monitoring entity (e.g., GE Nuclear Energy) for generation of a report that is thereafter provided to the utility.

Referring now to FIG. 3, and one exemplary embodiment of a monitoring system 20 of the present invention having a plurality of sensors 24, the data analysis component 27 comprises a PLC 60 connected to the plurality of sensors 24. The PLC 60 includes the data storage device 26, which may be, for example, a PCMCIA card connected thereto. In this embodiment, the following sensors 24 are provided for monitoring various operating conditions and parameters of the motor 22:

(1) Upper bearing temperature sensor (e.g. thermocouple) 24a;

(2) Lower bearing temperature sensor (e.g. thermocouple) 24b;

(3) Winding temperature sensor (e.g. thermocouple) 24c;

(4) Ambient temperature sensor (e.g. thermocouple) 24d;

(5) Upper oil reservoir condition sensor 24e;

(6) Lower oil reservoir condition sensor 24f;

(7) X-Axis vibration sensor 24g;

(8) Y-Axis vibration sensor 24h;

(9) Insulation resistance sensor 24i;

(10) Current sensor 24j; and

(11) Motor current signature analysis sensor 24k.

The monitoring system 20 also includes a power supply 62 for powering the signal conditioning component 28, and in particular, the signal conditioners 64 (i.e., signal converters) therein. A user activated component, for example, an inspection pass/no pass button 66 is also provided and may be activated to indicate, for example, whether the motor 22 passed or did not pass a visual inspection. This may also indicate that the removable data storage device 26 should be removed and the operating data stored therein downloaded to, for example, a computer, for analysis. It should be noted that the power supply 62 and power supply for other components of the monitoring system 20 (e.g., the PLC 60) may be provided from the power supply (not shown) for the motor 22.

Thus, as shown in FIG. 3, a monitoring system 20 may be provided for monitoring a motor 22 (e.g., electric motor for a vertical pump) to measure operating conditions and parameters. It should be noted that some of the sensors 24 may be integrated and include multiple sensor leads 70 for connection to the motor 22. For example, the upper oil reservoir condition sensor 24e and lower oil reservoir condition sensor 24f may be integrated into a single unit (e.g., single signal processor/conditioner) via two leads 70, one connected to the upper oil reservoir 72 of the motor 22 and one connected to the lower oil reservoir 74 of the motor 22. Further, in one embodiment, the data storage device 26 may be configured for removal to communicate (e.g., download) operating data to different devices, such as, for example, a PDA 76 or computer 78. The downloading may be provided by a hardwired connection to the data storage device 26 (e.g., inserting a PCMCIA card into a laptop computer 78) or wirelessly, for example, using the infrared port of the PDA 76.

The monitoring system 20 in one embodiment is encased within a sealed housing (e.g., NEMA-12 box) with the component parts mounted therein using, for example, DIN rails. The sealed housing is configured for mounting therein the signal conditioning component 28, the data analysis component 27, the data storage device 26 and the power supply 62. The DIN rails may be positioned, for example, to allow for optimal connection of the sensors 24 to a particular motor 22.

Further, the bearing temperature sensors 24a and 24b may be installed in the monitoring system 20 during motor refurbishment using original design hardware. The winding temperature sensor 24c may be connected to a spare detector in a slot in the motor 22, or added to a winding end-turn during motor refurbishing. The insulation resistance sensor 24i may be connected to the three-phase Y neutral of the motor 22 to minimize sensor insulation stress. The oil reservoir condition sensors 24e and 24f may be installed in the oil flow path inside the reservoirs 72 and 74 during motor refurbishment. The current sensor 24j may be connected to the housing with its leads molded into the lead bushing of the motor 22.

In operation the monitoring system 20 monitors operating conditions and parameters using the sensors 26. These parameters may be related, for example, to failure modes determined from FMEA and industry failure data. In the exemplary embodiment shown in FIG. 3, these conditions and parameters include, but are not limited to: (1) upper and lower bearing temperature; (2) winding temperature; (3) winding insulation resistance; (4) x-axis and y-axis vibration; (5) oil condition; (6) current; (7) ambient air temperature; and (8) external visual condition.

Specifically, the bearing temperature sensors 24a and 24b, which may be configured, for example, as thermocouples or resistance temperature detectors (RTDs), monitor bearing temperature to indicate degrading condition in the bearing or lubrication system of the motor 22. The winding temperature sensor 24c, which may be configured, for example, as a thermocouple or RTD, monitors winding temperature compensated for load to indicate degrading trends due to dirt accumulation or electrical condition. The insulation resistance sensor 24i, which may be, for example, an insulation sensor sold by Meg-Alert, PhaseMeg, or Fluke, monitors the motor's winding insulation condition relative to IEEE 43 standard when the motor 22 is de-energized to provide warning of a degrading trend. The vibration sensors 24e and 24f, which may be, for example, vibration sensors sold by Bently Nevada, IRD, Robertshaw or Wilcoxon, monitor velocity, amplitude and phase at critical bearings perpendicular to shaft axis (i.e., 2 channels) to provide an indication of a changing mechanical or electrical condition.

The oil reservoir condition sensors 24e and 24f, which may be, for example, sensors sold by CSI, Bently Nevada/GE Inspection Services, GE Syprotec, Kavlico or Innovative bynamics, Inc. (IDI), monitor oil in both reservoirs 72 and 74 to detect contamination level contributing to bearing failure and lubricant condition. The current sensor 24j and MCSA sensor 24k monitor motor current for determining a load/winding temperature correlation and current conditions for use in MCSA analysis, as well as rotor analysis. The ambient air sensor 24d is provided by any suitable air temperature sensor (e.g., thermocouple or RTD) to measure the ambient air temperature around the motor 22.

Further, the external condition of the motor 22 is examined (e.g., visual inspection of oil level, oil leaks, dirt accumulation, discoloration, abnormal noise, or other operating conditions), for example, by power plant personnel. The push button 66 may then be activated to indicate that removal of the data storage device 26 is needed to review and analyze the operating data if it is determined that the conditions of the motor 22 are, for example, degrading.

Each sensor 24 transmits a signal indicative of the operating condition or parameter monitored and as described above, to the PLC 60 for analysis and storage in the data storage device 26. In one embodiment, the PLC 60 may receive signals in the range of 0-20 VDC, 4-20 mA, and/or RTDs/thermocouples operating range. The signals received from the sensors 24 are conditioned (i.e., converted) to meet one of these three ranges by the signal conditioning component 28 in any known manner.

The PLC 60 upon receiving the operating data from the sensors 24, compares the collected operating data to rule-based criteria, for example, tolerance values within the database 30 to determine different operating characteristics (e.g., short-term trend characteristics). Operating data outside the criteria will cause the activation of the indication light 50, indicating a need to retrieve and transfer the operating data in the data storage device 26 for review and analysis. This may include, for example, removing the data storage device 26 and downloading the operating data to a computer 78. The data storage device 26 is replaced with another data storage device 26 to provide continued and uninterrupted storage of operation data. The retrieved (e.g., downloaded) operating data then may be distributed (e.g., e-mailed or shipped) to a utility or monitoring entity for generation of a report (e.g., operating characteristics trends report) for use in analysis of the motor 22 being monitored. For example, the operating data may be reviewed and analyzed to determine trends of the various motor parameters for use in maintenance of the motor 22. An integrated assessment also may be provided by combining operating data (e.g., mechanical and electrical condition data) from different sensors 26. Further, a report may be provided and include, for example, information about a trend analysis, the current condition of the motor 22, and comments on remaining motor life expectancy and need for future maintenance.

It should be noted that the data storage device 26 may be removed from the monitoring system 20 whenever needed or desired, and not only after the indication light 50 is activated. For example, the data storage device 26 may be removed and replaced, with the operating data contained therein downloaded periodically (e.g., once a week). Thus, operating and maintenance costs for a motor 22 may be reduced, such as, for example, by reducing unnecessary time-directed maintenance on motors 22 under inspection programs. Further, costs from unexpected motor failures may be reduced. Also, direct labor and material costs associated with plant engineers manually collecting routine operating information and samples (e.g., oil samples) may be reduced.

Thus, the monitoring system 20 monitors various operating conditions and parameters of motors 22 (e.g., mechanical and electrical conditions), compares measured values to criteria (e.g., tolerance thresholds and/or original OEM design criteria) to provide a warning indication and stores the operating data for later downloading and remote analysis. The operating data then may be used to determine operating characteristics or operating trends of the motor 22 being monitored.

Although various embodiments of the monitoring system 20 have been described having component parts configured in a particular manner for monitoring various operating conditions and parameters of motors 22, they are not so limited, and modifications and variations are contemplated. For example, the monitoring system 20 may include hard-wiring or different types of wireless communication to transfer data for analysis. Further, and for example, the monitoring system 20 may be provided self-contained within a motor 22 or provided separate and connected to the motor 22. When provided separate from the motor 22 the monitoring system 20 may include, for example, an external power source and separate connections to a motor control center remote from the motor 22.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A monitoring system for a motor comprising:
a plurality of sensors for monitoring operating conditions of a motor; and
a removable data storage device for storing data relating to the monitored operating conditions.

2. The monitoring system according to claim 1 further comprising:
a database having stored therein tolerance values for operating conditions.

3. The monitoring system according to claim 2 further comprising:
a data analysis component for comparing the data relating to the monitored operating conditions to the tolerance values in the database, and configured to provide a warning indication when a tolerance value is exceeded.

4. The monitoring system according to claim 3 further comprising:
a signal conditioning component configured to convert a signal representative of an operating condition from the plurality of sensors for input to the data analysis component.

5. The monitoring system according to claim 1 wherein the operating conditions comprise at least one of bearing temperature, winding temperature, ambient temperature, oil condition, vibration, insulation resistance and current, and wherein the plurality of sensors are configured to separately monitor each of the operating conditions.

6. The monitoring system according to claim 1 wherein the removable data storage device is configured for remote interface and access of the stored data.

7. The monitoring system according to claim 1 wherein the monitoring system is configured to be powered from a power source powering the motor being monitored.

8. The monitoring system according to claim 1 further comprising:
a user activated component for generating a signal when activated by a user, the signal indicating a condition relating to an external operating condition of the motor.

9. A monitoring device for monitoring operating conditions of an electric motor, the monitoring device comprising:
a programmable device for receiving data relating to the monitored operation conditions and configured to determine whether an operating condition threshold is exceeded, and
a data storage device for storing the received data and configured for removable connection to the programmable device.

10. The monitoring device according to claim 9 further comprising:
a database having stored therein tolerance values for operating conditions, and wherein the programmable device is configured to compare the monitored operating conditions to the tolerance values to determine whether the operating condition threshold is exceeded.

11. The monitoring device according to claim 9 wherein the programmable device is configured to provide a warning indication when an operating condition threshold is exceeded.

12. The monitoring device according to claim 9 wherein the operating conditions comprise at least one of bearing temperature, winding temperature, ambient temperature, oil condition, vibration, insulation resistance and current, and further comprising:
a plurality of sensors configured to separately monitor each of the operating conditions.

13. The monitoring device according to claim 9 further comprising:
a signal conditioning component configured to convert a signal representative of an operating condition for input to the programmable device.

14. The monitoring device according to claim 9 wherein the data storage device is configured for remote interface and access of the stored data.

15. The monitoring device according to claim 14 wherein the data storage device comprises a memory card for connection to a remote device for accessing the stored data.

16. The monitoring device according to claim 9 wherein the monitoring device is adapted for connection to the electric motor and configured for receiving power therefrom.

17. The monitoring device according to claim 9 wherein the programmable device is configured to store data to the data storage device at predetermined time intervals and maintaining storage of the data for a predetermined time period.

18. A method for monitoring the operating conditions of a motor, the method comprising:
monitoring at least one operating condition of the motor;
determining whether the at least one monitored operating condition exceeds a threshold; and
storing data relating to the at least one monitored operating condition in a removable data storage device.

19. The method according to claim 18 wherein the step of storing comprises periodically storing the data.

20. The method according to claim 18 wherein the determining comprises comparing the at least one monitored operating condition to a tolerance threshold to determine when the threshold is exceeded.

21. The method according to claim 18 wherein the monitoring comprises separately monitoring each of a plurality of operating conditions at the same time.

22. The method according to claim 18 further comprising:
providing a warning indication when the at least one monitored operating condition is determined to exceed a threshold.

23. A method for monitoring the operating conditions of an electric motor in a nuclear power plant, the method comprising:
measuring separately a plurality of operating conditions of the motor, the operating conditions monitored at the same time;
determining whether any of the measured operating conditions exceed a threshold;
providing a warning indication when the threshold is exceeded; and
storing data relating to the at least one measured operating condition in a removable data storage device.
